(19) United States
(12) Patent Application Publication
(10) Pub. No.: US 2021/0122127 A1
(43) Pub. Date: Apr. 29, 2021

(54) TIRE MANUFACTURING METHOD

(71) Applicant: Toyo Tire Corporation, Itami-shi (JP)

(72) Inventor: Yoshitaka Mizutani, Itami-shi (JP)

(73) Assignee: Toyo Tire Corporation, Itami-shi (JP)

(21) Appl. No.: 17/064,745

(22) Filed: Oct. 7, 2020

(30) Foreign Application Priority Data
Oct. 28, 2019 (JP) 2019-195451

(51) Int. Cl. B29D 30/32

(52) U.S. Cl. CPC B29D 30/32

(57) ABSTRACT

A tire manufacturing method comprises causing a bead member having a bead core region and a bead filler region to be wrapped cylindrically about the outer circumferential surface of a carcass ply member which is wrapped cylindrically about a drum, and causing an outer zone of the carcass ply member to be folded back upon itself by way of a folded region so as to envelop the bead member, the bead filler region comprises a first rubber region that is contiguous with the bead core region, and a second rubber region that is contiguous with the first rubber region, and when the bead member is wrapped about the outer circumferential surface of the carcass ply member, the second rubber region is already contiguous with the first rubber region.

### CROSS REFERENCE TO RELATED APPLICATIONS

This application claims the benefit of priority of Japanese application no. 2019-195451, filed on Oct. 28, 2019, which is incorporated herein by reference.

### BACKGROUND OF THE INVENTION

### Field of the Invention

The present disclosure relates to a tire manufacturing method.

### Description of the Related Art

Conventionally, e.g., in the context of a tire manufacturing method, an outer zone of a carcass ply member might be folded back upon itself toward the interior so as to envelop a bead member that is wrapped around the outer circumferential surface of the carcass ply member (e.g., JP2007-301830A). In addition, the bead member might comprise a bead core region and a bead filler region.

At the tire manufacturing method associated with JP2007-301830A, the bead filler region is divided into a first rubber region and a second rubber region, the first rubber region being contiguous with the bead core region, and the second rubber region being contiguous with the carcass ply member. In addition, when the carcass ply member outer zone is folded back upon itself toward the interior, this causes the second rubber region to be contiguous with the first rubber region.

However, it is sometimes the case with the tire manufacturing method associated with JP2007-301830A that the second rubber region is not contiguous with the first rubber region at the proper location. At such times, when this is made into a tire, because the shape of the bead filler may not be the proper shape, it is sometimes the case that there is an effect on tire performance.

### SUMMARY OF THE INVENTION

It is therefore an object of the present disclosure to provide a tire manufacturing method capable of causing a second rubber region to be contiguous with a first rubber region at a proper location.

There is provided a tire manufacturing method comprises:

causing a bead member having a bead core region and a bead filler region to be wrapped cylindrically about the outer circumferential surface of a carcass ply member which is wrapped cylindrically about a drum; and

causing an outer zone of the carcass ply member to be folded back upon itself by way of a folded region so as to envelop the bead member;

wherein the bead filler region comprises a first rubber region that is contiguous with the bead core region, and a second rubber region that is contiguous with the first rubber region; and

wherein when the bead member is wrapped about the outer circumferential surface of the carcass ply member, the second rubber region is already contiguous with the first rubber region.

### BRIEF DESCRIPTION OF DRAWINGS

FIG. 1 is a view of a section, taken along a tire meridional plane, of the principal components in a tire;

FIG. 2 is an enlarged view of region II in FIG. 1;

FIG. 3 is a sectional view of the bead member associated with an embodiment;

FIG. 4 is a schematic diagram illustrating a tire manufacturing method associated with same embodiment;

FIG. 5 is an enlarged view of region V in FIG. 4;

FIG. 6 is a side view illustrating a wrapping operation in a tire manufacturing method associated with same embodiment;

FIG. 7 is a sectional view illustrating a wrapping operation in a tire manufacturing method associated with same embodiment;

FIG. 8 is a sectional view illustrating a wrapping operation in a tire manufacturing method associated with same embodiment; and

FIG. 9 is a sectional view illustrating a folding operation in a tire manufacturing method associated with same embodiment.

### DETAILED DESCRIPTION OF THE INVENTION

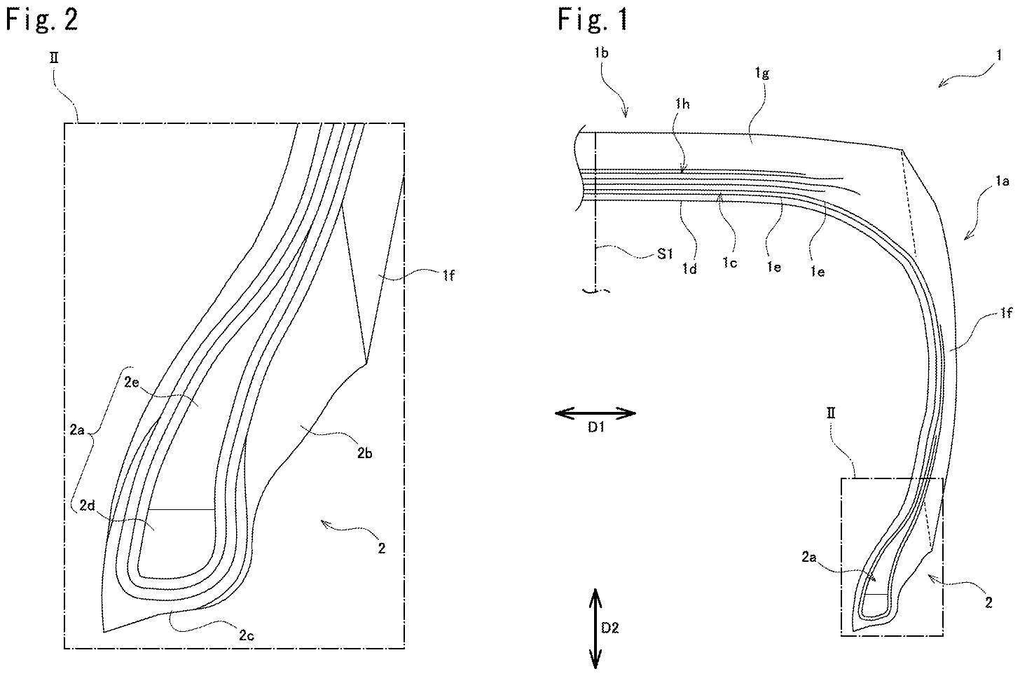

Below, an embodiment of a tire manufacturing method is described with reference to FIG. 1 through FIG. 9. At the respective drawings, note that dimensional ratios at the drawings and actual dimensional ratios are not necessarily consistent, and note further that dimensional ratios are not necessarily consistent from drawing to drawing.

A tire such as may be manufactured by a tire manufacturing method will first be described with reference to FIG. 1 and FIG. 2.

As shown in FIG. 1, tire 1 comprises a pair (only one of which is shown in FIG. 1) of bead regions 2, 2 at which beads 2a are present; a pair (only one of which is shown in FIG. 1) of sidewall regions 1a, 1a which extend outwardly in the tire radial direction D2 from the respective bead regions 2; and tread region 1b which is contiguous with the outer ends in the tire radial direction D2 of the pair of sidewall regions 1a, 1a. Note that tire 1 may be mounted on a rim (not shown).

At FIG. 1, first direction D1 is the tire width direction D1 which is parallel to the tire rotational axis that is the center of rotation of tire 1, second direction D2 is the tire radial direction D2 which is the direction of the diameter of tire 1, and third direction D3 (not shown) is the tire circumferential direction D3 which is circumferential with respect to the rotational axis of the tire. Furthermore, tire equatorial plane S1 refers to a plane that is located centrally in the tire width direction D1 of tire 1 and that is perpendicular to the rotational axis of the tire; tire meridional planes refer to planes that are perpendicular to tire equatorial plane S and that contain the rotational axis of the tire.

Tire 1 comprises carcass layer 1c which spans the pair of beads 2a, 2a, and innerliner layer 1d which is arranged at a location toward the interior from carcass layer 1c and which has superior functionality in terms of its ability to impede passage of gas therethrough so as to permit air pressure to be maintained. Carcass layer 1c and innerliner layer 1d are arranged in parallel fashion with respect to the inner circumferential surface of the tire over a portion thereof that encompasses bead regions 2, sidewall regions 1a, and tread region 1b.

Carcass layer 1c comprises carcass plies 1e, 1e. While there is no particular limitation with respect to the number of carcass plies 1e, 1e, note that the number of carcass plies 1e, 1e that are provided in the present embodiment is two. In addition, each of carcass plies 1e, 1e folds back upon itself about bead 2a so as to envelop bead 2a.

To constitute the tire outer surface, sidewall region 1a comprises sidewall rubber 1f which is arranged toward the exterior in the tire width direction D1 from carcass layer 1c. Furthermore, to constitute the tread surface (contact patch) which comes in contact with the ground, tread region 1b comprises tread rubber 1g which is arranged at the outer circumferential surface side of carcass layer 1c, and belt layer 1h which is arranged between carcass layer 1c and tread rubber 1g.

As shown in FIG. 2, to constitute the outer surface, bead region 2 comprises rim strip rubber 2b which is arranged toward the exterior in the tire width direction D1 from carcass layer 1c, and chafer 2c which is folded back upon itself about bead 2a so as to envelop bead 2a from the outside of carcass layer 1c. Note that while there is no particular limitation with respect thereto, the rubber hardness of rim strip rubber 2b may be greater than the rubber hardness of sidewall rubber 1f. Furthermore, while there is no particular limitation with respect thereto, chafer 2c may comprise a plurality of cords, and topping rubber with which said cords are covered.

Bead 2a comprises bead core 2d which is formed so as to be annular in shape, and annular bead filler 2e which is contiguous with the outside in the tire radial direction D2 of bead core 2d. Note that while there is no particular limitation with respect thereto, bead core 2d may be formed by laminating rubber-covered bead wire(s) (e.g., bronze-plated steel wire(s) or the like). Furthermore, while there is no particular limitation with respect thereto, the rubber hardness of bead filler 2e may be greater than the rubber hardness of sidewall rubber 1f.

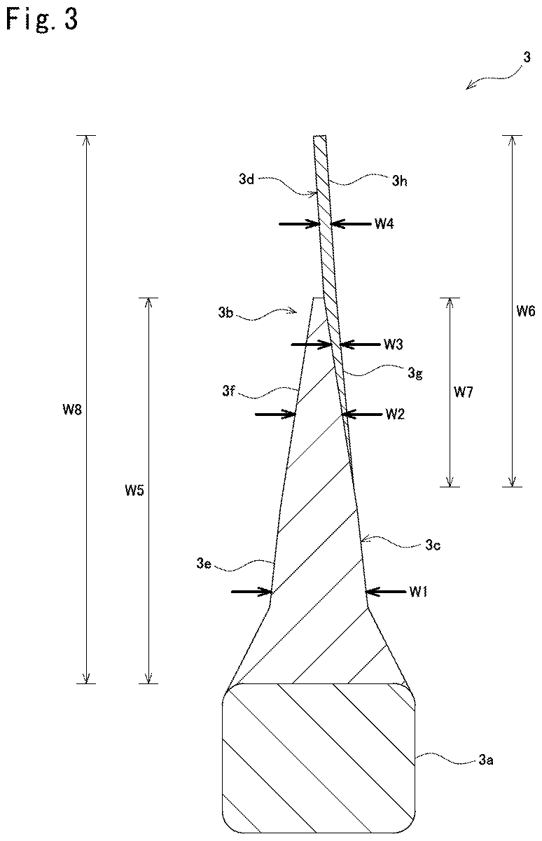

Next, bead member 3 which makes up beads 2a upon formation of tire 1 will be described with reference to FIG. 3.

As shown in FIG. 3, bead member 3 comprises bead core region 3a which makes up bead core 2d upon formation of tire 1, and bead filler region 3b which makes up bead filler 2e upon formation of tire 1. Bead filler region 3b comprises first rubber region 3c which is contiguous with bead core region 3a, and second rubber region 3d which is contiguous with first rubber region 3c. In accordance with the present embodiment, the material of first rubber region 3c is the same as the material of second rubber region 3d. Note, however, that it is also possible to adopt a constitution in which the material of first rubber region 3c is different from the material of second rubber region 3d.

First rubber region 3c comprises basal region 3e, which is contiguous with bead core region 3a, at the base side thereof; and comprises first contiguous region 3f, which is contiguous with the base side of second rubber region 3d, at the tip side thereof. Width W1 of basal region 3e decreases as one proceeds toward the tip of first rubber region 3c, and width W2 of first contiguous region 3f decreases as one proceeds toward the tip of first rubber region 3c. More specifically, widths W1, W2 of first rubber region 3c decrease as one proceeds toward the tip of first rubber region 3c.

Second rubber region 3d comprises second contiguous region 3g, which is contiguous with the tip side, i.e., first contiguous region 3f, of first rubber region 3c, at the base side thereof; and comprises protruding region 3h, which protrudes from first rubber region 3c, at the tip side thereof. Furthermore, second rubber region 3d is formed so as to be strip-like (e.g., sheet-like) in shape. In addition, because the surface of first contiguous region 3f at first rubber region 3c is formed so as to be planar in shape, second rubber region 3d adheres to first contiguous region 3f in parallel fashion with respect to the surface of first contiguous region 3f.

While there is no particular limitation with respect thereto, widths W3, W4 of second rubber region 3d might be not greater than 3 mm. This will make it possible to suppress formation of a step between first rubber region 3c and second rubber region 3d. And not only that, but width W3 of second contiguous region 3g decreases as one proceeds toward the base of second rubber region 3d. This makes it possible to effectively suppress formation of a step between first rubber region 3c and second rubber region 3d.

As a result, upon formation of tire 1, it will be possible, for example, to suppress entry of air into the space between first rubber region 3c and second rubber region 3d. Note that width W4 of protruding region 3h is uniform. Furthermore, the average of widths W1, W2 of first rubber region 3c is greater than the average of widths W3, W4 of second rubber region 3d.

Note that while there is no particular limitation with respect thereto, height W5 of first rubber region 3c may be greater than height W6 of second rubber region 3d.

Furthermore, while there is no particular limitation with respect thereto, height W7 of second contiguous region 3g might be not less than 30% of height W6 of second rubber region 3d. Furthermore, while there is no particular limitation with respect thereto, height W5 of first rubber region 3c might be not less than 60% of height W8 of bead filler region 3b. Such a constitution will make it possible to ensure that bead filler region 3b is able to stand on its own and to suppress the natural inclination of bead filler region 3b to collapse.

It may be the case where the amount of rubber in the rubber is large and where this is to be extruded from an opening fixture by means of a screw, that the rubber is expelled therefrom at high temperature. In such case, adhesion of the rubber will be poor. To address this, while there is no particular limitation with respect thereto, height W8 of bead filler region 3b might be not less than 60 mm, and height W5 of first rubber region 3c and height W6 of second rubber region 3d might be not greater than 45 mm.

As a result, to address the fact that the amount of rubber at bead filler region 3b may be large, it is possible by causing bead filler region 3b to be divided into first rubber region 3c and second rubber region 3d to suppress increase in the amount of rubber at rubber regions 3c, 3d. Accordingly, it will be possible to cause first rubber region 3c and second rubber region 3d to be expelled therefrom in respectively independent fashion at temperatures not greater than a prescribed temperature (e.g., 95° C.).

As a result, it will be possible to ensure that there will be satisfactory adhesion at first rubber region 3c and second rubber region 3d. As a result, it will be possible to definitively cause second rubber region 3d to adhere to first rubber region 3c, and to definitively cause bead filler region 3b to adhere to element(s) 4c adjacent thereto (see FIG. 9).

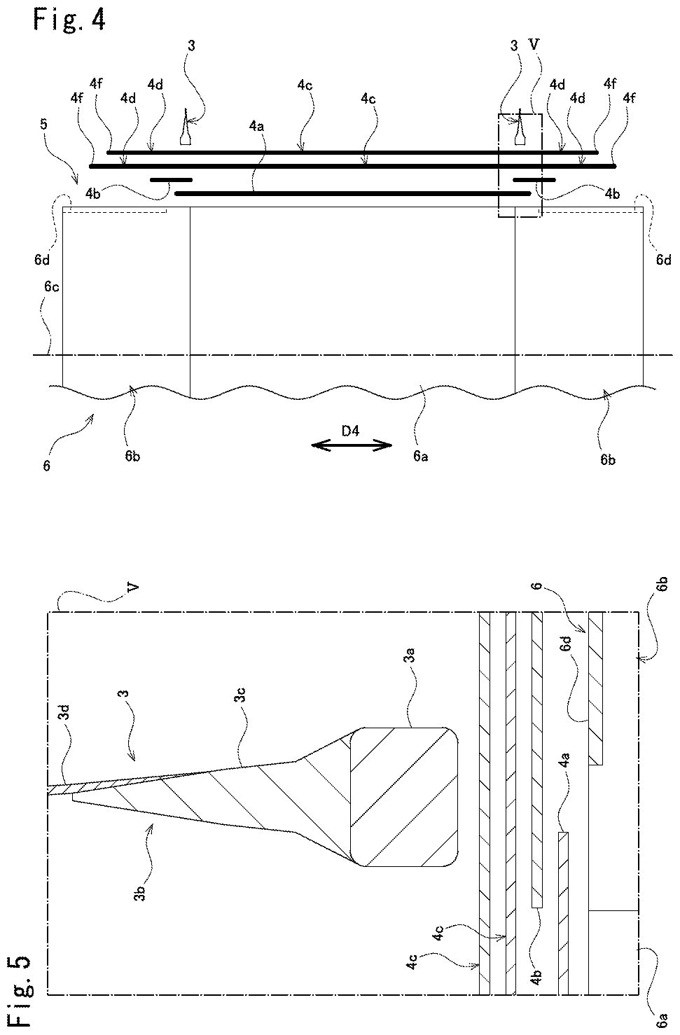

Next, a tire manufacturing device will be described with reference to FIG. 4.

As shown in FIG. 4, tire manufacturing device 5 comprises drum 6 which supports constituent elements 4a through 4c of tire 1. Drum 6 is divided into three in the axial direction D4 of drum 6. More specifically, drum 6 comprises central drum 6a which is located in the central region thereof, and end drums 6b, 6b which are located at either end thereof. In addition, central drum 6a and end drums 6b, 6b are constituted so as to be respectively and independently capable of being increased and/or decreased in size. Note that drum 6 is constituted so as to be capable of rotation about rotational axis 6c.

End drum 6b comprises folding fixture 6d that causes carcass ply members 4c, 4c to be pressed against bead member 3 in such fashion as to cause carcass ply members 4c, 4c to be folded back upon themselves. While there is no particular limitation with respect to the constitution of folding fixture 6d, folding fixture 6d of the present embodiment, being a pouch-like body comprising rubber and/or other such elastic body, is a bladder that expands when a gas is made to flow into the interior thereof.

Next, a tire manufacturing method will be described with reference to FIG. 4 through FIG. 9.

<Wrapping Operation>

Firstly, as shown in FIG. 4 and FIG. 5, innerliner member 4a which makes up innerliner layer 1d, chafer member 4b which makes up chafer 2c, and carcass ply members 4c, 4c which make up carcass plies 1e, 1e are stacked in this order, being wrapped cylindrically about the outer circumferential surface of drum 6. To facilitate understanding of how respective members 3 and 4a through 4c are arranged, note that respective members 3 and 4a through 4c are shown spaced apart at FIG. 4 and FIG. 5. Furthermore, at FIG. 4, only respective members 3 and 4a through 4c are shown in sectional view.

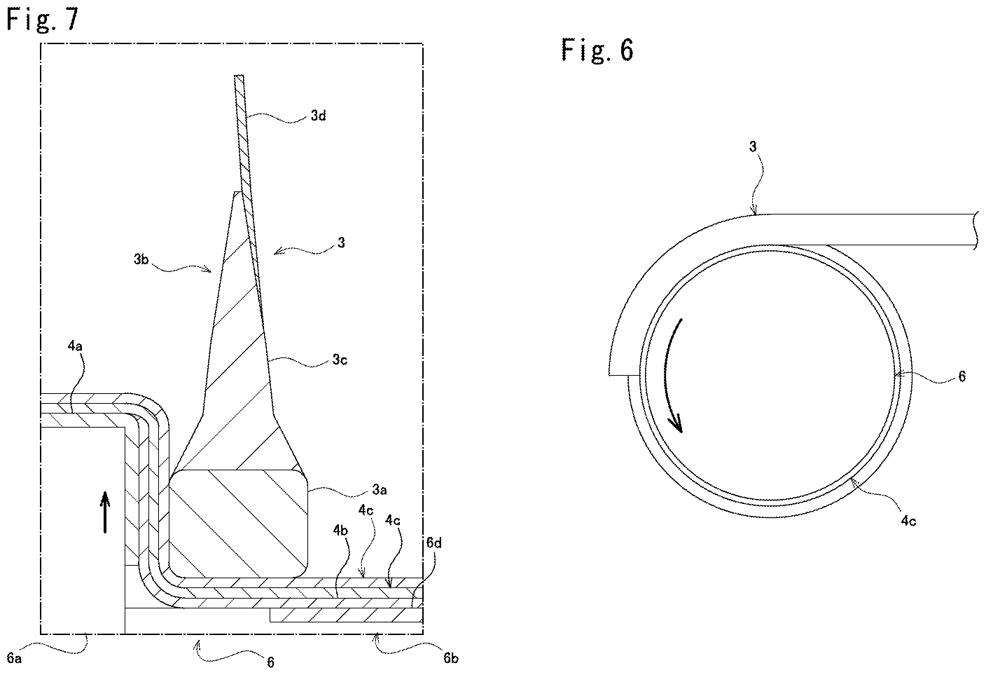

In addition, as shown in FIG. 6 and FIG. 7, bead member 3 is wrapped cylindrically about the outer circumferential surface of carcass ply member 4c. More specifically, the tip region of bead member 3 is made to adhere to the outer circumferential surface of carcass ply member 4c, rotation of drum 6 causing bead member 3 to be wrapped about the outer circumferential surface of carcass ply member 4c.

At such time, bead member 3 is wrapped about the outer circumferential surface of carcass ply member 4c in such fashion as to cause second rubber region 3d to be contiguous with first rubber region 3c. Note that second rubber region 3d is arranged toward the exterior in the axial direction D4 from first rubber region 3c.

Furthermore, central drum 6a is larger in diameter than end drum 6b, a step being formed between the outer circumferential surface of central drum 6a and the outer circumferential surface of end drum 6b. This being the case, bead member 3 will be wrapped thereabout in such fashion as to follow the edge at the exterior side in the axial direction D4 of said step.

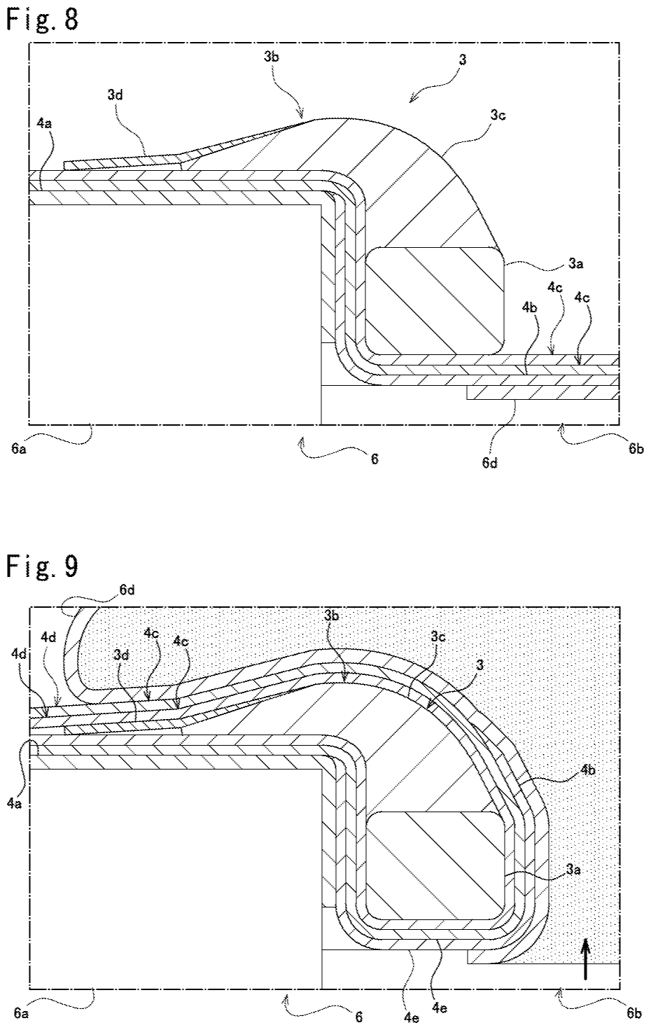

In addition, as shown in FIG. 8, roller(s) or the like, not shown, press on the interior side in the axial direction D4 of bead filler region 3b, causing it to bend so as to conform to the outer circumferential surface of carcass ply member 4c. At such time, because second rubber region 3d is arranged toward the exterior in the axial direction D4 from first rubber region 3c, pressing on second rubber region 3d with roller(s) or the like causes second rubber region 3d to be pressed against first rubber region 3c.

<Folding Operation>

By thereafter causing the interior of folding fixture 6d to be filled with a gas, folding fixture 6d is made to expand. As a result, carcass ply members 4c, 4c and chafer member 4b are together folded back about bead member 3 so as to envelop bead member 3. More specifically, outer zones 4d, 4d of carcass ply members 4c, 4c are folded back toward the interior in the axial direction D4 so as to envelop bead member 3.

At such time, bead member 3 is wrapped about carcass ply member 4c in such fashion as to cause second rubber region 3d to be contiguous with first rubber region 3c. As a result, it will be possible to cause second rubber region 3d to be contiguous with first rubber region 3c at the proper location. Accordingly, even where, for example, the shape of bead filler region 3b is such that there is a large amount of rubber therein, it will nonetheless be possible to cause bead filler region 3b to be the proper shape. As a result, upon formation of tire 1, it will be possible, for example, to suppress situations in which air might otherwise enter thereinto by going past bead region 2 (see FIG. 2).

Furthermore, because folding fixture 6d presses thereon in such fashion that pressure is directed toward end 4f (see FIG. 4) from folded region 4e of carcass ply member 4c, carcass ply member 4c is compression bonded to bead member 3. And not only that, but because second rubber region 3d is arranged between first rubber region 3c and outer zone 4d of carcass ply member 4c, when folding fixture 6d presses on carcass ply member 4c, the pressing which is produced thereby will occur in order from the base of second rubber region 3d toward first rubber region 3c. As a result, it will be possible to cause second rubber region 3d to be definitively compression bonded to first rubber region 3c.

<Molding Operation and Vulcanization Operation>

The respective members (not shown) that make up rim strip rubber 2b, sidewall rubber 1f, belt layer 1h, and tread rubber 1g are thereafter wrapped thereabout so as to be respectively stacked thereover, and the unvulcanized tire is molded (molding operation). In addition, the unvulcanized tire is vulcanized (vulcanizing operation), following which the vulcanized tire is mounted on a rim, and the interior of the tire is furthermore filled with air, to manufacture pneumatic tire 1.

As described above, the tire manufacturing method of the embodiment includes:

causing a bead member 3 having a bead core region 3a and a bead filler region 3b to be wrapped cylindrically about the outer circumferential surface of a carcass ply member 4c which is wrapped cylindrically about a drum 6; and

causing an outer zone 4d of the carcass ply member 4c to be folded back upon itself by way of a folded region 4e so as to envelop the bead member 3;

wherein the bead filler region 3b comprises a first rubber region 3c that is contiguous with the bead core region 3a, and a second rubber region 3d that is contiguous with the first rubber region 3c; and

wherein when the bead member 3 is wrapped about the outer circumferential surface of the carcass ply member 4c, the second rubber region 3d is already contiguous with the first rubber region 3c.

In accordance with such method, bead member 3 is wrapped cylindrically about the outer circumferential surface of carcass ply member 4c in such fashion that second rubber region 3d is contiguous with first rubber region 3c. In addition, due to the fact that outer zone 4d of carcass ply member 4c is folded back upon itself toward the interior in the axial direction D4, bead member 3 is enveloped by carcass ply member 4c. This makes it possible to cause second rubber region 3d to be contiguous with first rubber region 3c at the proper location.

Further, in the tire manufacturing method of the embodiment,

wherein a folding fixture 6d presses on the carcass ply member 4c that has been folded back upon itself in such fashion that pressure is directed toward an end 4f of the carcass ply member 4c from the folded region 4e of the carcass ply member 4c so as to cause the carcass ply member 4c to be compression bonded to the bead member 3;

the first rubber region 3c comprises a first contiguous region 3f arranged at a tip side thereof;

the second rubber region 3d is contiguous with the first contiguous region 3f; and

when the carcass ply member 4c is compression bonded to the bead member 3, the second rubber region 3d is arranged between the first rubber region 3c and the outer zone 4d of the carcass ply member 4c.

In accordance with such method, second rubber region 3d is contiguous with the tip side of first rubber region 3c. In addition, when folding fixture 6d presses on carcass ply member 4c in such fashion that pressure is directed toward end 4f from folded region 4e, because second rubber region 3d is arranged between first rubber region 3c and outer zone 4d of carcass ply member 4c, second rubber region 3d is pressed on in order from the base thereof toward first rubber region 3c.

Further, in the tire manufacturing method of the embodiment,

wherein the second rubber region 3d comprises, at a base side thereof, a second contiguous region 3g that is contiguous with the first contiguous region 3f; and

as viewed in a section taken along a diameter of the cylindrical bead member 3, width W3 of the second contiguous region 3g decreases as one proceeds toward the base of the second rubber region 3d.

In accordance with such method, contiguous region 3g at the base side of second rubber region 3d is contiguous with the tip side of first rubber region 3c, and width W3 of contiguous region 3g decreases as one proceeds toward the base of second rubber region 3d. This makes it possible to suppress formation of a step between first rubber region 3c and second rubber region 3d.

The tire manufacturing method is not limited to the configuration of the embodiment described above, and the effects are not limited to those described above. It goes without saying that the tire manufacturing method can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of the tire manufacturing method associated with the foregoing embodiment is such that second rubber region 3d is arranged between first rubber region 3c and outer zone 4d of carcass ply member 4c when outer zone 4d of carcass ply member 4c is folded back upon itself. However, the tire manufacturing method is not limited to such constitution.

For example, it is also possible to adopt a constitution in which first rubber region 3c is arranged between second rubber region 3d and outer zone 4d of carcass ply member 4c when outer zone 4d of carcass ply member 4c is folded back upon itself. That is, it is also possible to adopt a constitution in which second rubber region 3d is arranged toward the interior in the axial direction D4 from first rubber region 3c when bead member 3 is wrapped about the outer circumferential surface of carcass ply member 4c.

(2) Furthermore, the constitution of the tire manufacturing method associated with the foregoing embodiment is such that folding fixture 6d presses in such fashion that pressure is directed toward end 4f from folded region 4e of carcass ply member 4c. However, the tire manufacturing method is not limited to such constitution. For example, it is also possible to adopt a constitution in which folding fixture 6d presses on the entirety of outer zone 4d of carcass ply member 4c simultaneously.

(3) Furthermore, the constitution of the tire manufacturing method associated with the foregoing embodiment is such that folding fixture 6d is a pouch-like body comprising an elastic body, being a bladder that expands when a gas is made to flow into the interior thereof. However, the tire manufacturing method is not limited to such constitution. For example, it is also possible to adopt a constitution in which folding fixture 6d comprises linked members, the linked members pressing thereon in such fashion that pressure is directed toward end 4f from folded region 4e of carcass ply member 4c (e.g., the constitution at JP2017-100293A).

(4) Furthermore, the constitution of the tire manufacturing method associated with the foregoing embodiment is such that second contiguous region 3g at the base side of second rubber region 3d is contiguous with first contiguous region 3f at the tip side of first rubber region 3c. However, the tire manufacturing method is not limited to such constitution. For example, it is also possible to adopt a constitution in which second rubber region 3d is contiguous with first rubber region 3c everywhere along the length thereof from the tip to the base thereof.

(5) Furthermore, the constitution of the tire manufacturing method associated with the foregoing embodiment is such that width W3 of contiguous region 3g decreases as one proceeds toward the base of second rubber region 3d. However, the tire manufacturing method is not limited to such constitution. For example, it is also possible to adopt a constitution in which width W3 of second contiguous region 3g is constant. Furthermore, it is also possible, for example, to adopt a constitution in which width W3 of second contiguous region 3g increases as one proceeds toward the base of second rubber region 3d.

1. A tire manufacturing method comprising:
causing a bead member having a bead core region and a bead filler region to be wrapped cylindrically about the outer circumferential surface of a carcass ply member which is wrapped cylindrically about a drum; and
causing an outer zone of the carcass ply member to be folded back upon itself by way of a folded region so as to envelop the bead member;
wherein the bead filler region comprises a first rubber region that is contiguous with the bead core region, and a second rubber region that is contiguous with the first rubber region; and
wherein when the bead member is wrapped about the outer circumferential surface of the carcass ply member, the second rubber region is already contiguous with the first rubber region.

2. The tire manufacturing method according to claim 1
wherein a folding fixture presses on the carcass ply member that has been folded back upon itself in such fashion that pressure is directed toward an end of the carcass ply member from the folded region of the carcass ply member so as to cause the carcass ply member to be compression bonded to the bead member;
the first rubber region comprises a first contiguous region arranged at a tip side thereof;
the second rubber region is contiguous with the first contiguous region; and
when the carcass ply member is compression bonded to the bead member, the second rubber region is arranged between the first rubber region and the outer zone of the carcass ply member.

3. The tire manufacturing method according to claim 2
wherein the second rubber region comprises, at a base side thereof, a second contiguous region that is contiguous with the first contiguous region; and
as viewed in a section taken along a diameter of the cylindrical bead member, width of the second contiguous region decreases as one proceeds toward the base of the second rubber region.

4. The tire manufacturing method according to claim 3
wherein the second rubber region comprises, at a tip side thereof, a protruding region that protrudes from the first rubber region; and
as viewed in a section taken along a diameter of the cylindrical bead member, width of the protruding region is constant.

5. The tire manufacturing method according to claim 4
wherein as viewed in a section taken along a diameter of the cylindrical bead member, width of the first contiguous region decreases as one proceeds toward the tip of the first rubber region.

6. The tire manufacturing method according to claim 5
wherein the first rubber region comprises, at a base side thereof, a basal region that is contiguous with a bead core region; and
as viewed in a section taken along a diameter of the cylindrical bead member, width of the basal region decreases as one proceeds toward the tip of the first rubber region.

7. The tire manufacturing method according to claim 6
wherein as viewed in a section taken along a diameter of the cylindrical bead member, width of the first rubber region decreases as one proceeds toward the tip of the first rubber region.

8. The tire manufacturing method according to claim 7
wherein as viewed in a section taken along a diameter of the cylindrical bead member, average width of the first rubber region is greater than average width of the second rubber region.

9. The tire manufacturing method according to claim 8
wherein as viewed in a section taken along a diameter of the cylindrical bead member, height of the first rubber region is greater than height of the second rubber region.

10. The tire manufacturing method according to claim 4
wherein as viewed in a section taken along a diameter of the cylindrical bead member, width of the second rubber region is not greater than 3 mm.

11. The tire manufacturing method according to claim 3
wherein as viewed in a section taken along a diameter of the cylindrical bead member, height of the second contiguous region is not less than 30% of height of the second rubber region.

12. The tire manufacturing method according to claim 1
wherein as viewed in a section taken along a diameter of the cylindrical bead member, height of the first rubber region is not less than 60% of height of the bead filler region.

13. The tire manufacturing method according to claim 12
wherein as viewed in a section taken along a diameter of the cylindrical bead member, the height of the bead filler region is not less than 60 mm, the height of the first rubber region is not greater than 45 mm, and height of the second rubber region is not greater than 45 mm.

14. The tire manufacturing method according to claim 1
wherein a material of the first rubber region is same as a material of the second rubber region.
